(19) United States
(12) Patent Application Publication
(10) Pub. No.: US 2007/0041122 A1
(43) Pub. Date: Feb. 22, 2007

(54) Communication method and system

(76) Inventor: Ivon Franciscus Helwegen, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,376

(22) PCT Filed: May 17, 2004
(86) PCT No.: PCT/IB04/01667

§ 371 Date: Nov. 18, 2005

(30) Foreign Application Priority Data
May 22, 2003 (EP) 03300019.1

(51) Int. Cl. G11B 5/596

(52) U.S. Cl. 360/78.06

(57) ABSTRACT

Abstract: The invention relates to a method of communicating between an application block and a drive block in a low power storage device. This method consists of executable instructions corresponding to the steps of sending from the application block, by means of an interface, specific commands giving the drive block knowledge about the application involved in said application block and, in reply to said commands, issuing a low power handling in the drive block. The invention also relates to a corresponding device for communicating between an application block and a drive block.

### FIELD OF THE INVENTION

The present invention generally relates to a method of communicating between an application block and a drive block in a low power storage device.

### BACKGROUND OF THE INVENTION

More and more applications like digital photo cameras, portable audio players, personal digital assistants, navigation systems or mobile phones use embedded storage devices. As most of these handheld applications use batteries, they need to be low power: low power consumption is indeed important to have sufficient battery life and to ensure proper functionality of the concerned system (the power consumption is the result of actions at different levels, such as the maximum power consumption of the active components of the system, the strategy used in it to fulfil the requests concerning the different possible modes, commands or constraints, etc).

In such applications, the storage device is normally connected to the application itself by means of a standard interface (like IDE or SCSI). The device, which does not have knowledge about the application itself where it is connected to and mostly acts as a slave without being able to take an optimal solution, can however take measures to be as low power as possible, i.e. to do as much as it can to reduce the power consumption. For instance, when a drive is a slave with respect to the application, one of the possible solutions to reduce the power consumption may be a strategy like keep an engine on (motor spinning, laser on, etc) for some seconds and switch to stand-by or sleep mode afterwards, with maybe some stages in between, before the engine totally switches off (harddisks for laptops, for example, use a similar strategy). However, it is not a really optimal solution, because the application may need data just after the engine has switched off and it needs to spin-up again.

In complete products (application+drive) like portable CD-players or portable MP3-players, most of the power consumption strategies are handled in the application, which is possible because there is only one drive and only one application (or a limited number of applications). Said application then knows—almost exactly—the power consumption of the drive and can take care of power consumption strategies. More specifically, a mobile optical storage device SFFO (Small Form Factor Optical), capable of storing one gigabyte of data on a disc having a diameter of roughly 28 millimeters, will be described with reference to FIG. 1.

The SFFO system of the basic block diagram of FIG. 1 comprises an application block 100 and an SFFO drive block 200, connected by means of a command/data interface 300.The SFFO drive block 200 consists of an SFFO datapath 201, that does the command handling from the application and does data handling between the application block 100 and a first memory 202 (Random Access Memory, or RAM), said memory 202, and an SFFO basic engine 203. The basic engine 203, itself consisting of the rest of the drive, includes on the one hand a channel codec, that reads from or writes in the memory 202, and on the other hand a servo system, controlled by the SFFO datapath 201 by means of low level commands.

The application block 100 comprises the SFFO application 101 itself, that sends commands to the SFFO drive block 200, a second memory 102 (also a RAM), and a user input/output stage 103, that encodes or decodes the user data (MPEG-video, MP3-audio, etc) and takes care of the input/output devices (such as keyboard, microphone, speaker, camera, display, etc). The SFFO application 101 does data handling between the SFFO drive block 200 and the second memory 102.

As shown in FIG. 1, the application block 100 and the drive block 200 both have an amount of RAM memory, and the smart buffering and low power handling often take place in the application block 100, as seen above for products like portable CD or Mp3 players. If the handling takes place in the application block 100, the application then needs to have knowledge about the drive, that receives detailed instructions from the application.

### SUMMARY OF THE INVENTION

It is an object of the invention to propose another solution, according to which the drive has no longer to act only as a slave.

To this end, the invention relates to a method of communication such as defined in the introductory paragraph of the description and which is moreover characterized in that it consists of executable instructions that correspond to the steps of:

sending from the application block, by means of an interface, specific commands giving the drive block knowledge about the application involved in said application block;

in reply to said commands, issuing a low power handling in the drive block.

The invention also relates to a system for communicating between an application block and a drive block in a low power storage device, said device comprising:

communication means operable to interface said application block and said drive block;

a device interface set of executable instructions residing on said application block and operable to carry out one or more commands from said application block.

### BRIEF DESCRIPTION OF THE DRAWINGS

The present invention will now be described, by way of example, with reference to the accompanying drawings in which:

FIG. 1 shows a basic block diagram of an SFFO system for a mobile optical storage device;

FIGS. 2 to 5 are tables illustrating proposed commands.

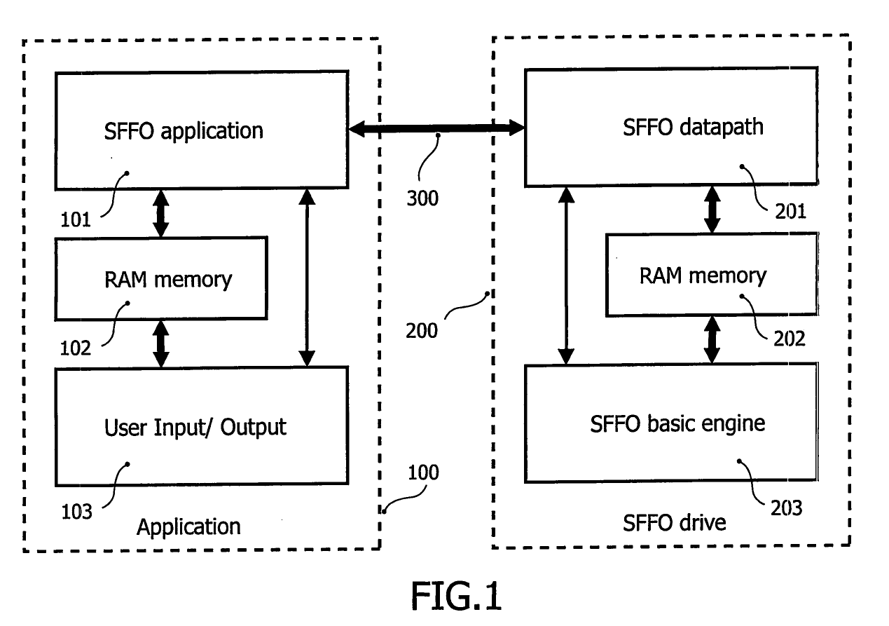

### DETAILED DESCRIPTION OF THE INVENTION

In known storage devices that are connected to an application, said application knows—or learns by means of measurements—the characteristics of the drive and can use them to drive the engine. So it depends on the application how optimal the drive is used. With the present technical solution, if one wants to give a minimum power consumption of the drive as a characteristic of this drive, and if smart buffering and low power handling take place in the drive block of the system, the drive itself takes care of the strategy to be low power and, the intelligence being thus put in the drive, it can do smart things with the instructions it receives from the application. Especially it can do a lot on the power consumption, without giving to the application a detailed knowledge on the drive.

Several interfaces can then be used between the application and the “smart” drive, e.g. IDE, SCSI, Compact Flash or Multimedia Card, but, in fact, the command set to give the drive knowledge about the application does not exist yet and some pseudo MMC commands that give the drive enough information about the application (application type command, announce stream command, read stream command, write stream command) will be described. It may be however recalled that, in current systems, the file-system is placed in the application. Because the drive becomes a lot smarter when it has to think about power consumption, the file-system may also be placed in the drive, which has some advantages: the application does not know anything anymore on the logical position of the files on the disc, but the drive now knows a lot about the files and may implement its own allocation strategy on how to place the files on the disc. However, such a system is not compatible with existing applications and command sets.

The description that follows will now, in the case of a mobile optical storage system SFFO with an SFFO drive block, give details about the commands used in the interface implemented between the application and its drive, in order to give the drive enough information about the application:

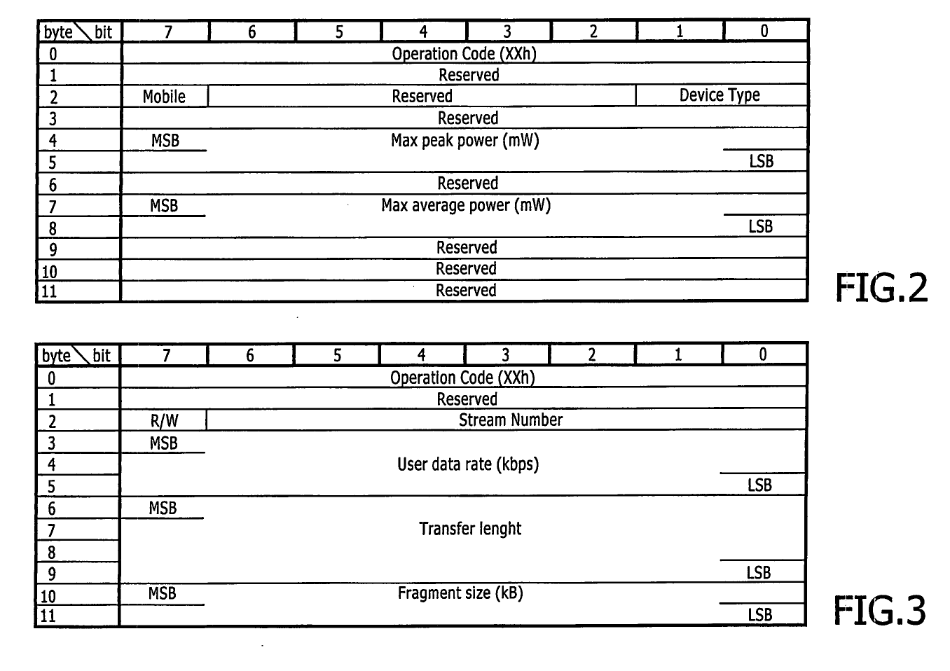

(A) application type command (see the table of FIG. 2):

It describes the application type the SFFO drive is plugged in. This command may be issued at power up, but also on the fly when the application thinks it is needed to update the information. The structure of this command includes 12 bytes of 8 bits, each byte having a specified use:

(1) operation code (8 bits);

(2) mobile bit (1 bit): it has to be asserted if the SFFO drive is plugged into a mobile application, i.e. in this case the drive knows it has to reserve some more memory for shock protection (and also the servo loop needs to be made somewhat tighter to overcome some shocks);

(3) device type bits (2 bits): they tell the drive what kind of device the SFFO drive is plugged in, and the values may be for example the following ones:

00=default: no power issues are considered (and no smart handling)

01=phone: maximum user data rate 1 Mbps, peak power<600 mW

10=move: ″ ″ ″ ″ ″ Mbps, ″ ″<1 W

11=cradle: ″ ″ ″ ″ ″ 36 Mbps, ″ ″<7 W

(4) max peak power (8 bits): it gives the maximum peak power the drive may issue in milliwatts (the application may issue this optional command on the fly: for example when a phone call comes in, the maximum peak power for the SFFO drive needs to be reduced);

(5) max average power (8 bits): it gives the maximum average power the drive may issue in milliwatts (the application may also issue this optional command on the fly).

(B) announce stream command (see the table of FIG. 3):

(1) operation code;

(2) read/write (1 bit): if the stream is to be read from, or if it is to be written on the disc.

(3) stream number (7 bits): with this unique number associated to the stream, the SFFO drive knows some things about the stream.

(4) user data rate (24 bits): user data rate in kbps.

(5) transfer length (32 bits): length of the stream.

(6) fragment size (16 bits): gives some information on fragments (optional).

(C) read stream command (in this example, it is an extension to the READ(12)MMC

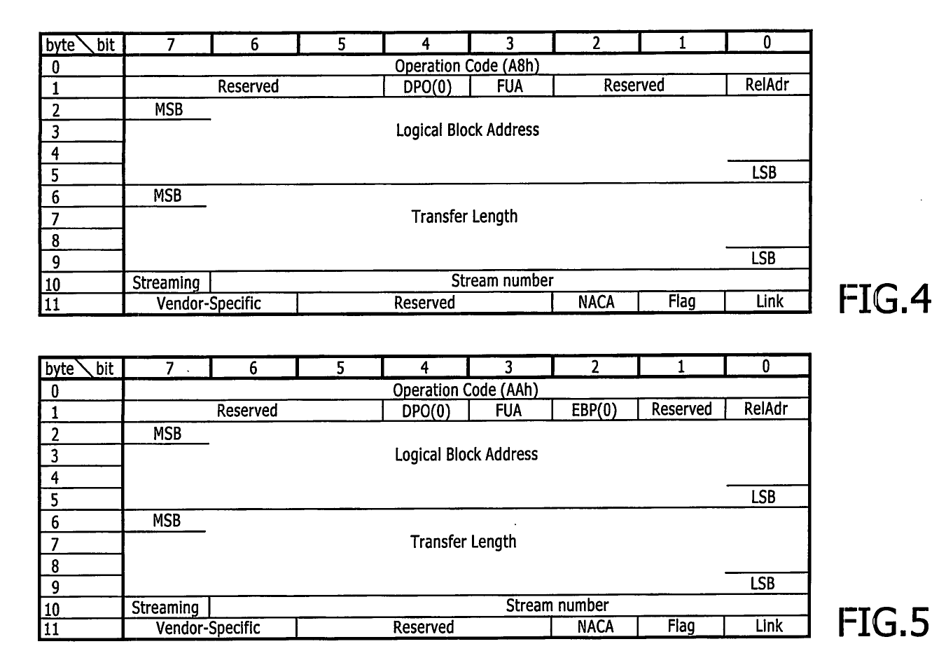

command): reads a block of data from the drive (table of FIG. 4).

(D) write stream command (table of FIG. 5): similarly, it is an extension to the WRITE(12) MMC command.

1. A method of communicating between an application block and a drive block in a low power storage device, said method consisting of executable instructions that correspond to the steps of:
sending from the application block, by means of an interface, specific commands giving the drive block knowledge about the application involved in said application block;
in reply to said commands, issuing a low power handling in the drive block.

2. A method according to claim 1, wherein said specific commands at least comprise an application type command describing the application type the drive is plugged in and defining the power conditions.

3. A method according to claim 2, wherein said application type command is issued on the fly.

4. A method according to claim 2, wherein said specific commands also comprise an announce stream command giving to the drive block information about the stream.

5. A method according to claim 4, wherein said announce stream command is changed on the fly.

6. A method according to claim 4, wherein said specific commands also comprise a read stream command and a write stream command.

7. A method according to claim 6, wherein said specific commands also involve a transmission of information about the operation environment—such as portable or non-portable environment—and/or the apparatus type—such as mobile, phone, laptop, etc.

8. A system for communicating between an application block and a drive block in a mobile low power storage device, said device comprising:
communication means operable to interface said application block and said drive block
a device interface set of executable instructions residing on said application block and operable to carry out one or more commands from said application block.

9. A system according to claim 8, wherein said commands at least comprise an application type command, describing the application type the drive is plugged in and defining the power conditions.

10. A system according to claim 9, wherein the values telling the drive what kind of device the drive is plugged in are the following ones:
00=default: no power issues are considered (and no smart handling)
01=phone: maximum user data rate 1 Mbps, peak power<600 mW
10=move: ″ ″ ″ ″ ″ 10 Mbps, ″ ″<1 W
11=cradle: ″ ″ ″ ″ ″ 36 Mbps, ″ ″<7 W

11. A system according to claim 9, wherein said commands also comprise an announce stream command, giving to the drive block information about the stream.

12. A system according to claim 11, wherein said commands also comprise a read stream command and a write stream command.

13. A system according to claim 11, wherein said commands also comprise a transmission of information about the operation environment—such as portable or non-portable environment—and/or the apparatus type—such as mobile phone, laptop, etc.

14. A system according to claim 13, wherein said commands are changed on the fly.

15. A system according to claim 8, wherein said low power storage device is a mobile optical storage apparatus.

16. A system according to claim 8, characterized in that it consists of a mobile optical storage system SFFO (Small Form Factor Optical) with an SFFO drive block.
